(19) United States
(12) Patent Application Publication
(10) Pub. No.: US 2003/0118212 A1
(43) Pub. Date: Jun. 26, 2003

(54) Method for registering iris code in iris recognition system

(75) Inventors: Seung Gi Min, Seoul (KR); Jang Jin Chae, Gunpo-si (KR)

Correspondence Address: FLESHNER & KIM, LLP, P.O. Box 221200, Chantilly, VA, 20153-1200, US

(73) Assignee: LG Electronics Inc.

(21) Appl. No.: 10/323,686

(22) Filed: Dec. 20, 2002

(30) Foreign Application Priority Data
Dec. 20, 2001 (KR) 81640/2001

(51) Int. Cl. G06K 9/00

(52) U.S. Cl. 382/100

(57) ABSTRACT

Disclosed is a method for registering Iris code in an Iris recognition system to avoid inconvenience of re-registration when a new Iris algorithm is applied. The method for registering Iris code includes the step of: when an old Iris code was registered on an Iris code database of the Iris recognition system to which the old Iris algorithm is applied, registering a new Iris code on the Iris code database, the new Iris code being generated using a new algorithm provided in the Iris recognition system. Accordingly, even though an Iris algorithm is changed in an Iris recognition system, the users do not have to register their Iris codes again and time to register Iris codes again are not wasted.

### BACKGROUND OF THE INVENTION

1. Field of the Invention

The present invention relates to a method for registering Iris code in an Iris recognition system, and more particularly, to a method for registering Iris code in an Iris recognition system to avoid inconvenience of re-registration when a new Iris algorithm is applied to.

2. Description of the Related Art

As known, further to the conventional contact type or non-contact type card systems for security, crime prevention or authentication of identification, systems which allow or deny the entrance to a specific area or the access to specific information according to authentication performed by recognizing finger print or Iris, have come to wide use.

The Iris recognition system has advantages, such as higher and more precise recognition rate compared with the finger print recognition system and impossibility in forgery and stealing since the Iris pattern is different every human being and there are amazingly a lot of kinds of the Iris patterns.

In general, the Iris has a characteristic in that the pattern thereof does not vary for a long time. In 1980s, American Ophthalmologists, e.g., Leonard Flom and Alan Safir found that every human being has his (her) inherent Iris patterns. A basic patent of the technology related to Iris recognition was registered in 1987. A professor, John G. Daugman of University of Cambridge of the United Kingdom proposed an image signal processing algorithm based on Gabor wavelet transform in which the Iris pattern can be coded in 256 bytes. The currently commercialized products are based on this algorithm.

An initial available Iris recognition system was developed in 1995 by IriScan, Inc. founded around core members of the aforementioned three peoples in the United States. The Iris recognition system includes an image capture unit for capturing an eye image and a recognition unit for recognizing a person using the captured eye image. The image capture unit functions to capture an eye image suitable for Iris recognition and the recognition unit performs functions, such as Iris region extraction, Iris feature extraction, registration and recognition from the captured eye image, Accordingly, the Iris recognition system is employed by banks that require a high security. Further, it is applied to entrance doors of buildings and personal computers to prevent personal information from leaking.

FIG. 1 illustrates a general Iris recognition system. Referring to FIG. 1, when a user accesses to an Iris recognition system, a distance measure sensor 109 measures a distance from the user and sends the measured distance to the a control device 105 through a driver 107. The control device 105 determines whether the inputted distance measurement value is within a predetermined operation range. The control device 105 sends a control signal to the driver 107 if the inputted distance measurement value is within a predetermined operation range. The driver 107 sends an active signal to an external indicator 108 to inform a user of the fact that system is operating by generating an indication. Here, the external indicator 108 can be a light emission device such as an LED. When a user positions his or her eye on light axis of a camera 103 through an optical window 101, a cold mirror 102 screens a visible ray and transmits an infrared ray. The location at which an Iris should be positioned is indicated for the user to ascertain whether his or her eye is located on the light axis of the camera 103. An illuminator controls illumination intensity. Here, the control device 105 controls the camera 103 to zoom-in, zoom-out, and focus using the distance measurement value measured deliberately. The control device 105 sends a camera control signal to the camera 103 to capture an Iris image from the user's eye. The Iris image captured by the camera 103 is sent to a frame grabber 104 and the frame grabber 104 generates an Iris code from the Iris image. Here, the Iris code implies Iris code and an Iris recognition algorithm separates its brightness pattern into eight circles. The eight circles are obtained by analysis on each area. The control device 105 registers this Iris code on the Iris code database 110 and determines authentication of the user using the authentication code. The performance of such an Iris recognition system depends on how fast and how precisely to recognize the Iris. The Iris recognition system under improvement is required to provide convenience to users. However, if a new Iris algorithm for Iris recognition is developed, a new Iris code for each user should be registered for the Iris algorithm.

FIG. 2 is a flowchart illustrating a method of registering a new Iris code on an Iris code database in a conventional Iris recognition system when a new Iris algorithm is applied to. As shown in FIG. 2, the camera captures an Iris image of the user's Iris again (S201). A new Iris algorithm uses the Iris image to generate a new Iris code (S202 and S203). The generated new Iris code is registered additionally on an Iris code database (S204). As described above, when a new algorithm is applied to in the conventional art, a new Iris code for user's Iris should be registered again.

FIG. 3 a flowchart illustrating a method of searching a new Iris code on an Iris code database in a conventional Iris recognition system when a new Iris algorithm is applied to. As shown in FIG. 3, after a user registers a new Iris code for the user deliberately, the user locates his or her eye on the light axis of the camera 103 through an optical window 101 for the Iris recognition system to recognize his or her Iris. The camera captures an Iris image of his or her Iris (S301). An Iris pattern is extracted from the Iris image captured by the new Iris algorithm and the Iris code is generated using the extracted Iris pattern (S302 and S303). It is determined whether the new Iris code registered deliberately for the user exists on the Iris code database (S304). In other words, the Iris code is compared with a number of Iris codes registered on the Iris code database and the new Iris code to match the Iris code is found. If the new Iris code to match the Iris code exists on the Iris code database, the user is authenticated by the Iris recognition system.

In the conventional Iris recognition system as described above, it is necessary to generate a new Iris code for each of the users and register it if a new Iris algorithm is used. Accordingly, it is necessary for users who have used the Iris recognition system while the old Iris algorithm is used to register their Iris codes again through the Iris recognition system in which a new Iris algorithm is used, which is very inconvenient for users. In other words, in the related art, whenever an Iris algorithm is changed, many users are required to register their Iris codes for later authentication. To this end, much time and efforts are wasted so as to register their Iris code on the new Iris algorithm.

### SUMMARY OF THE INVENTION

Accordingly, the present invention is directed to a method for registering Iris code in an Iris recognition system that substantially obviates one or more problems due to limitations and disadvantages of the related art.

An object of the present invention is to provide a method for registering Iris code in an Iris recognition system, in which an Iris code is updated without separately registering the Iris code on a new algorithm when the Iris code was registered on a previous Iris algorithm.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a method for registering Iris code in an Iris recognition system. The method includes the step of: when an old Iris code was registered on an Iris code database of the Iris recognition system to which an old Iris algorithm is applied, registering a new Iris code on the Iris code database, the new Iris code being generated using a new algorithm provided in the Iris recognition system.

The old Iris code is replaced with the new Iris code. It is desired that the new Iris code is Iris code.

In another aspect of the present invention, a method for registering Iris code in an Iris recognition system includes the steps of: (a) generating a new Iris code using a new Iris algorithm; (b) determining whether the new Iris code exists on an old Iris code database using the new Iris algorithm; and (c) registering the new Iris code on the new Iris database if the generated Iris code does not exist on an old Iris code database.

In another aspect of the present invention, a method for registering Iris code in an Iris recognition system includes the steps of: (a) extracting an Iris pattern by using a new Iris algorithm based on an Iris image captured from a user; (b) generating a new Iris code from the extracted Iris pattern; (c) determining whether an old. Iris code generated by an old algorithm exists on a Iris code database if the new Iris code does not exist on the Iris code database; and (d) registering the new Iris code on the Iris database if the old Iris code exists on the Iris code database.

The method further includes the step of: (e) reporting an Iris recognition authentication result to the user Iris code on the new Iris algorithm it the new Iris code exists on the Iris code database. The step (c) includes the steps of: (c-1) extracting an Iris pattern by using the old Iris algorithm based on the Iris image; and (c-2) searching the old Iris code generated from the extracted Iris pattern on the Iris code database. The old Iris code is replaced with the new Iris code in the step (d).

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates the conventional Iris recognition system;

FIG. 2 is a flowchart illustrating a method of registering a new Iris code to Iris code database in a conventional Iris recognition system when a new Iris algorithm is applied;

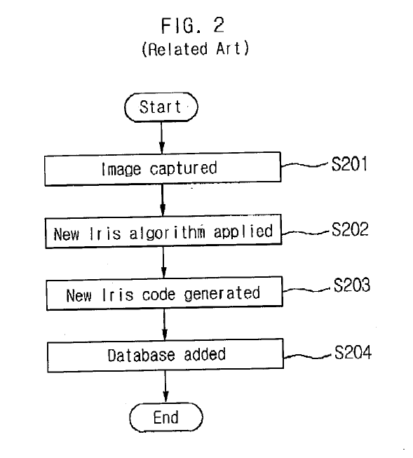

FIG. 3 a flowchart illustrating a method of searching a new Iris code on Iris code database in a conventional Iris recognition system when a new Iris algorithm is applied; and

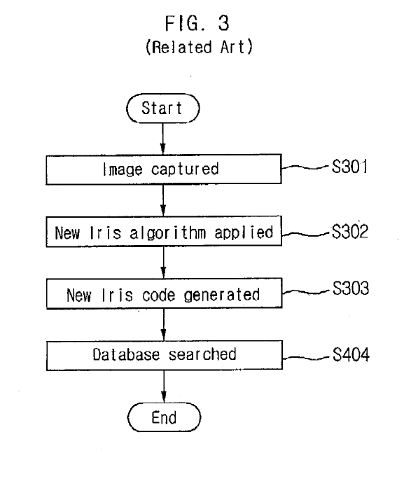

FIG. 4 is a flowchart illustrating a method of updating automatically a new Iris code on Iris code database according to the preferred embodiment of the present invention.

### DETAILED DESCRIPTION OF THE INVENTION

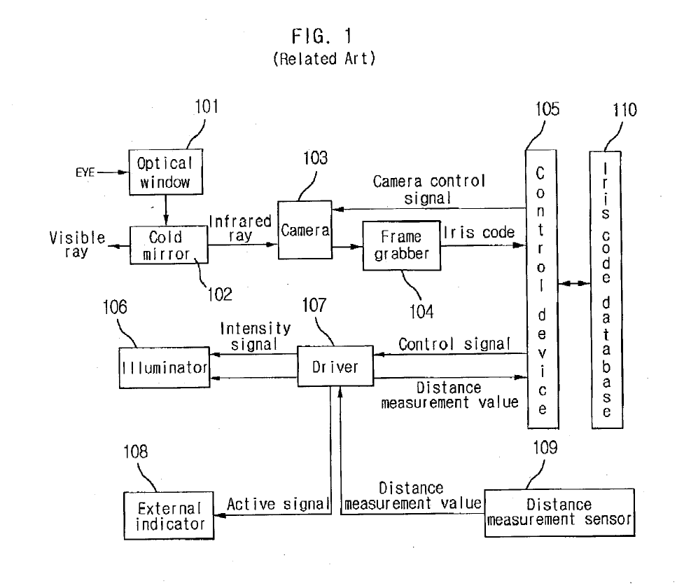

Reference will now be made in detail to the preferred embodiments of the present invention, examples of which are illustrated in the accompanying drawings. Wherever possible, the same reference numbers of FIG. 1 will be used as the reference numbers used to describe a method for registering Iris code of Iris recognition according to the present invention.

As to the present invention, if a new Iris algorithm is used in the Iris recognition system that has used an old Iris algorithm and an old Iris code generated by the Iris algorithm was registered deliberately, even though a user does not register his or her Iris code separately, the new Iris code generated using the new Iris algorithm is substituted for the old Iris code and registered. Here, the new Iris algorithm implies the algorithm that is substituted for the old Iris algorithm and applied to the Iris recognition system.

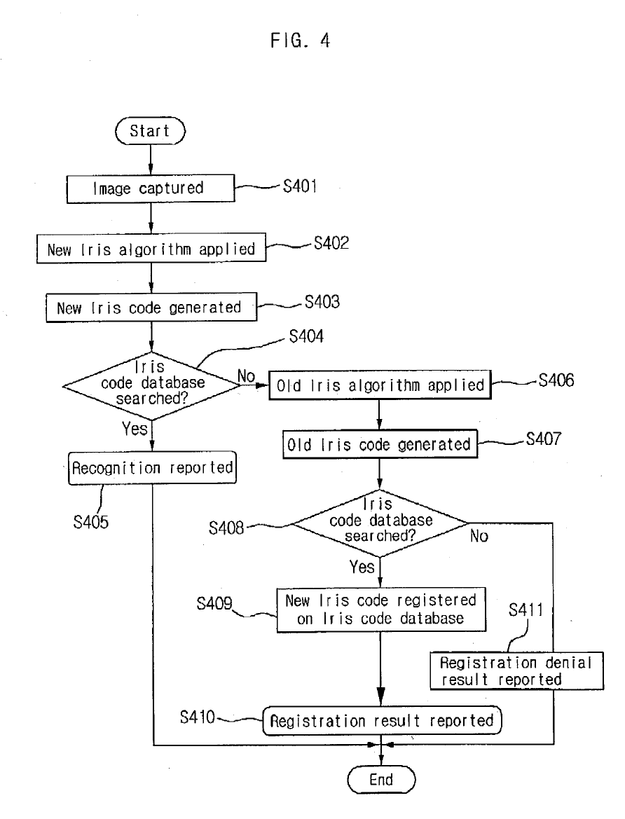

FIG. 4 is a flowchart illustrating a method of updating automatically a new Iris code on Iris code database according to the preferred embodiment of the present invention. Referring to FIG. 4, first, it a user's Iris is located on the light axis of a camera 103, the camera obtains an image from the Iris (S401). The obtained image is captured into an Iris image by a frame grabber 104 and a new Iris algorithm is applied to analyze the Iris pattern on the Iris image. Digital signal processing is performed on the analyzed Iris pattern and the digital signal processed Iris image is sent to the control device 105 (S402). The control device 105 uses the new Iris algorithm to generate a new Iris code from the Iris pattern (S403). The control device 105 compares the new Iris code with each of the Iris codes on the Iris code database and determines whether the new Iris code exists in the Iris code database (S404). It a new Iris code is not found in the Iris code database, the old Iris algorithm is used (S406). In other words, the Iris algorithm is applied on the captured image to extract Iris pattern (S406). The Iris algorithm is applied on the extracted Iris pattern to generate the old Iris pattern (S407). If the new Iris code exists in the Iris code database, an Iris authentication recognition result is reported to the user (S405). The control device 105 compares an old Iris code with each of the Iris codes on the Iris code database and determines whether the old Iris code exists in the Iris code database (S408). If the old Iris code exists in the Iris code database, the new Iris code is registered to the Iris code database (S409). Here, the old Iris code on the Iris code database is replaced with the new Iris code and the registration result is reported to the user (1410). It the old Iris code does not exist in the Iris code database as the result of determination of the step S408, a registration denial result is reported to the user (S411).

on the other hand, even though FIG. 4 shows that one Iris code database is used, two Iris code databases may be used. In other words, the Iris code database may include a new Iris code database used to determine whether a new Iris code generated at the step S403 exists in the new Iris code database, and an old Iris code database used to determine whether an old Iris code generated at the step S407 exists in the old Iris code database. When two Iris code databases are used, the old Iris code on the one Iris code database is not replaced with the new Iris code as shown in FIG. 4 but the new Iris code is simply stored on the new Iris code database. Accordingly, in the present invention, registration is confirmed using the new Iris code generated by the new Iris algorithm. If the new Iris code is not registered, registration is confirmed again using the old Iris code generated by the old Iris algorithm. Here, If the old Iris code is registered, the new Iris code is updated and registered to the Iris code database. Then, the updated new Iris code is later used as recognition information for Iris recognition to recognize corresponding user.

As a result, the present invention allows to register users who are not registered and to recognize users who are already registered without any performing registration and recognition steps on users separately even though a new Iris algorithm is applied.

As described above, according to the Iris code registration of the Iris recognition system, when a new Iris algorithm is applied and old Iris codes are registered on an old Iris algorithm according to the method described above, Iris codes for all users are not registered separately and new Iris codes for all users which are not registered on the new Iris algorithm are can be registered automatically. Accordingly, the users do not have to register their Iris codes again and time and efforts to register Iris codes are reduced.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A method for registering Iris code in an Iris recognition system, the method comprising the step of;
when an old Iris code was registered on an Iris code database of the Iris recognition system to which an old Iris algorithm is applied, registering a new Iris code on the Iris code database, the new Iris code being generated using a new algorithm provided in the Iris recognition system.

2. The method according to claim 1, wherein the old Iris code is updated with the new Iris code.

3. The method according to claim 1, wherein the new Iris code is an Iris code.

4. A method for registering Iris code in an Iris recognition system, the method comprising the steps of:
(a) generating a new Iris code using a new Iris algorithm;
(b) determining whether the new Iris code exists on an old Iris code database using the new Iris algorithm; and
(c) registering the new Iris code on the new Iris database if the generated Iris code does not exist on an old Iris code database.

5. The method according to claim 4, further comprising the step of:
(d) reporting an Iris recognition authentication result to a corresponding user if the generated Iris code exists on an old Iris code database.

6. The method according to claim 4, wherein the new Iris code is Iris code.

7. A method for registering Iris code in an Iris recognition system, the method comprising the steps of:
(a) extracting an Iris pattern by using a new Iris algorithm based on an Iris image captured from a user;
(b) generating a new Iris code from the extracted Iris pattern;
(c) determining whether an old Iris code generated by an old algorithm exists on a Iris code database if the new Iris code does not exist on the Iris code database; and
(d) registering the new Iris code on the Iris database if the old Iris code exists on the Iris code database.

8. The method according to claim 7, wherein the new Iris code is Iris code.

9. The method according to claim 7, further comprising the step of:
(e) reporting an Iris recognition authentication result to the user if the new Iris code exists on the Iris code database.

10. The method according to claim 7, wherein the step (c) comprises the steps of:
(c-1) extracting an Iris pattern by using the old Iris algorithm based on the Iris image; and
(c-2) searching the old Iris code generated from the extracted Iris pattern on the Iris code database.

11. The method according to claim 7, wherein the old Iris code is replaced with the new Iris code in the step (d).
